(19) United States
(12) Patent Application Publication
(10) Pub. No.: US 2008/0190150 A1
(43) Pub. Date: Aug. 14, 2008

(54) Two-Part Rotary Lock

(76) Inventor: Rainer Hoffmann, Langenfeld (DE)

Correspondence Address: ROBERT W. BECKER & ASSOCIATES, 707 HIGHWAY 333, SUITE B, TIJERAS, NM, 87059-7507, US

(21) Appl. No.: 11/547,552

(22) PCT Filed: Mar. 18, 2005
(86) PCT No.: PCT/EP2005/002911

§ 371 Date: Sep. 29, 2006

(30) Foreign Application Priority Data
Mar. 31, 2004 (DE) 20 2004 005 030.7

(51) Int. Cl. E05B 17/00

(52) U.S. Cl. 70/91

(57) ABSTRACT

The invention relates to a two-part turnbuckle lock for a door or flap, especially of switch cabinets or the like. Said lock comprises a housing (12), fastened on the door leaf (10) or flap, and an operating shaft (17). Said shaft is rotationally arranged inside the housing (12), is linked with a turnbuckle tongue (16) on the inside of the door leaf (10) in a rotationally fixed manner and can be coupled with an actuator (25), such as a handle, cylinder lock or the like on the outside of the door leaf (10). The housing (12), for the purpose of fastening on the door leaf (10), comprises a rosette (13) mounted on the outside of the door leaf (10) and an outer thread (14) on the inside of the door leaf (10) for screwing a fixing nut (15) thereonto until it rests against the door leaf (10). The inventive lock is characterized in that the rosette (13) and the housing (12) of the turnbuckle are configured as separate parts and can be interlinked by means of a positively locking connection (20, 21).

The present invention relates to a casement or rotary lock or latch for a door or flap, in particular of switch cabinets or the like, having a housing that is secured in position on the door panel or the flap, and an actuating shaft that is rotatably disposed in the housing, on the inside of the door panel is connected with a rotary tongue so as not to rotate relative thereto, and on the outside of the door panel can be coupled to a lock actuator, such as a handle, cylinder lock or the like, whereby the housing, for securement thereof to the door panel, is provided with a collar that is disposed on the outside of the door panel and on the inside of the door panel is provided with an external thread for threading thereon of a fastening nut until it rests against the door panel.

A rotary lock having the aforementioned features is described in EP 0 175 211 B1. With the known lock, the collar that is disposed on the outside of the door panel is a unitary component of the housing of the rotary lock, so that to mount the rotary lock on a door panel, the housing must be inserted from the outside of the housing into the mounting opening provided in the door panel. On the inside of the door panel, a fastening nut that is embodied as an annular nut is threaded onto the external thread of the housing until it comes to rest against the inside of the door panel, whereby the collar serves as a counter-bearing. Thus, the door panel is clamped between the collar and the threaded-on fastening nut, as a result of which the rotary lock is secured to the door panel.

To the extent that the actuating shaft, including the rotary tongue carried by it, is already preassembled in the housing of the rotary lock prior to mounting of the rotary lock on the door panel, the fastening nut, for the mounting of the rotary lock on the door panel, must be threaded over the rotary tongue, which is correspondingly cumbersome. In addition, each change of the appearance of the collar, which is visible on the outside of the door panel, involves a change of the overall housing, so that accommodating a customer's desire with regard to the optical appearance of a rotary lock is very expensive.

It is therefore an object of the present invention to simplify the mounting of a rotary lock having the aforementioned features, and also to enable different designs of the collar.

The realization of this object, including advantageous embodiments and further developments of the invention, result from the content of the patent claims, which follow this description.

The basic concept of the invention is that the collar and the housing of the rotary lock are separate components that can be interconnected by means of a positive or interlocking connection. The invention has the advantage that during the preassembly of the housing with the actuating shaft, the fastening nut can already be threaded onto the housing, because now the collar and the housing are placed separately on the door panel, and only during the final mounting of the rotary lock are they to be interconnected. Thus, for the mounting of the rotary lock, it is merely necessary to place the housing on the inside of the door panel, and to place the collar on the front side of the door panel, whereby the two components are to be brought into engagement as a function of the interlocking configurations that are used, preferably by a rotation relative to one another. By tightening the fastening nut, which is prethreaded onto the outer circumference of the housing, until it comes to rest against the door panel, a fixed connection between collar and housing of the rotary lock is established. Furthermore, making the housing and collar separate has the advantage that the collar can be produced as an individual component and can thus be easily adapted to customer desires with regard to its appearance.

Pursuant to one embodiment of the invention, an extension of the housing projects outwardly beyond the door panel in the direction of the collar, and the periphery of the extension is surrounded by the collar, thus facilitating provision of an interlocking connection.

Pursuant to an embodiment of the invention, the interlocking connection is embodied as a bayonet closure. For this purpose, radially extending projections can be formed on the extension of the housing that during mounting of collar and housing against one another can be introduced into recessed areas formed on the collar, and that by a relative rotation between collar and housing can be locked with the collar.

The housing can, in an advantageous manner, be fixed in position in the mounting opening of the door panel so as to be protected against rotation, whereby pursuant to an embodiment of the invention, the mounting opening, which is formed in the door panel and accommodates the housing, can be provided on its edge with at least one support surface, which corresponds to a projection, to form a protection against rotation or twisting of the housing in the mounting opening.

To the extent that for this purpose the cooperation of at least one support surface with a projection is sufficient, pursuant to an embodiment of the invention a support surface is associated with each of the projections formed on the housing. In this connection, the support surfaces are preferably disposed in the corner regions of the substantially square mounting opening.

With regard to sealing of the rotary lock, pursuant to one embodiment of the invention the collar is provided with a seal that is disposed in the abutment surface of the collar against the door panel; furthermore, a seal can be disposed between the inner surface of the collar that surrounds the housing and the outer periphery of the extension of the housing.

Pursuant to one embodiment of the invention, the respectively provided seal is fixedly connected with the collar, whereby pursuant to alternative embodiments of the invention, the pertaining seal can be foamed or can be inserted or integrated, for example in the so-called 2K process, during the manufacture of the collar, which is preferably made of polymeric material.

Pursuant to one embodiment, a viewing window can be formed in the collar, and the actuating shaft projects outwardly beyond the extension of the housing that guides it into the region of the viewing window of the collar and at its projecting region is provided with a recognition mark or indication such that the rotational position of the actuating shaft can be determined by the indication, which is visible in the viewing window of the collar; this provides the possibility for being able to determine the interlocking or unlocking state of the rotary lock by a simple visual inspection of the viewing window. In this connection, pursuant to embodiments of the invention, the mark or indication can be comprised of a differing color, for example red or green, or can be comprised of a position indicator composed of lettering, for example in the form “open/closed” or “on/off”.

One embodiment of the invention, which will be described subsequently, is shown in the drawing, in which:

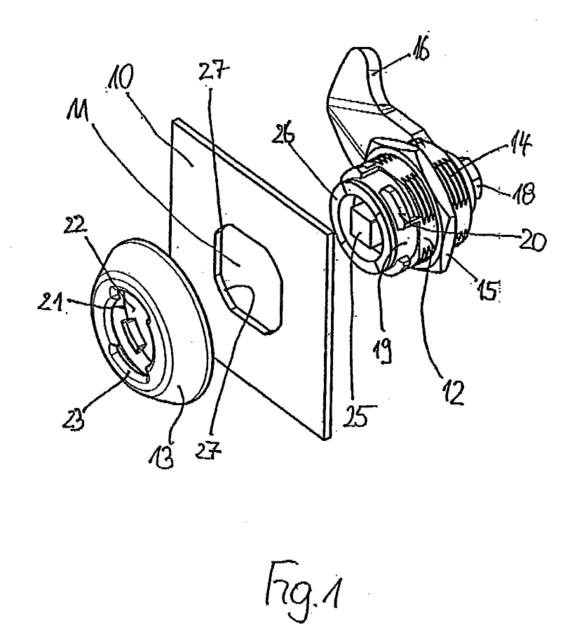

FIG. 1: is a perspective illustration of a rotary lock with the housing and collar prior to mounting on the door panel,

FIG. 2: is a front view of the subject matter of FIG. 1 after mounting on the door panel,

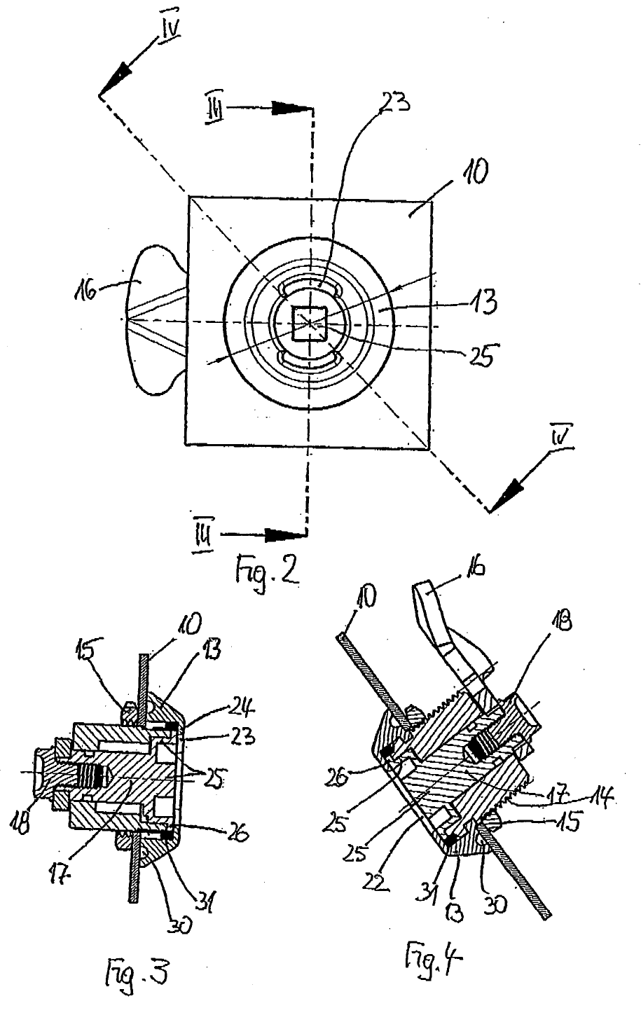

FIG. 3: is a cross-sectional view of the subject matter of FIG. 2 taken along the line III-III in FIG. 2,

FIG. 4: is a cross-sectional view of the subject matter of FIG. 2 taken along the line IV-IV in FIG. 2.

To the extent that the rotary lock is to be mounted on a door panel 10, only the portion of which is illustrated, the door panel 10 is provided with a mounting opening 11. The rotary lock comprises a housing 12, which is to be placed on the inside of the door panel, and a collar 13 that is to be mounted on the outside. An extension 19 of the housing 12 extends through the mounting opening 11 of the door panel 10 and engages into the collar 13 in such a way that the collar 13 surrounds the extension 19 of the housing 12. For mutual interlocking, four radially extending projections 20 are formed on the extension 19 with which recessed areas 21, which are disposed in the inner surface of the collar 13 that surrounds the extension 19, are associated in such a way that in a specific rotational position of the collar 13 and the housing 12 relative to one another, the projections 20 of the housing are introducible into the recessed areas 21 of the collar 13, and after reciprocal rotation the projections 20 of the housing 12 are moved out of the recessed areas and catch behind appropriately disposed projections of the collar 13. For the securement, a fastening nut 15 is furthermore threaded onto an external thread 14 disposed on the outer side of the housing 12; during the mounting of the rotary lock on the door panel 10, with the mutual positive connection of collar 13 and housing 12, the fastening nut is rotated until it rests tightly against the inner side of the door panel 10. In this position, the housing 12 and collar 13 can no longer detach from one another, so that the rotary lock is mounted on the door panel 10 as a unit. To provide protection against twisting, the shape for the mounting opening 11 is adapted to the outer circumference of the projection 19, including the four radially extending projections 20, with the corner regions of the edge of the mounting opening 11, which accommodate the projections 20 of the extension 19, being embodied as inclined support surfaces 27 that correspond to the outer surfaces of the projections 20 in such a way that the housing 12, with its projections 20, is fixed in position in the mounting opening 11 in a positively engaging manner, and hence is protected against twisting. To this extent, the projections 20 have an appropriately large axial width, so that they extend into the recessed areas 21 of the collar 13 beyond resting against the support surfaces 27. With this configuration, interlocking of the collar 13 and housing 12 is effected by a relative rotation of the collar 13 relative to the housing 12, which is fixed in position in the mounting opening 11 so as to be protected against twisting.

Disposed in the interior of the housing 12 is an actuating shaft 17, on the end of which a rotary tongue 16 is disposed so as to be fixed against rotation relative thereto; the rotary tongue is secured by a screw nut 18. An actuation configuration 25 of the actuating shaft 17 extends into the extension 19 of the housing 12, and on its outer end is provided with an end flange 26 that overlaps the end rim of the housing 12. The end flange 26 of the actuating shaft 16, in other words of the actuation configuration 25, is in turn overlapped by a shoulder surface 24, which surrounds the insertion opening 22 in the collar 13. So that the rotational position of the rotary lock can be visible, disposed in the shoulder surface 24 are oppositely located cutouts as viewing windows 23, whereby these viewing windows 23 provide an end view of the flange 26 of the actuating shaft 17. The outer end face of the flange 26 is provided with different colors, for example red and green, so that in one rotational position, preferably the interlocking position of the actuating shaft 17, the region of the flange 26 colored in red is disposed in the viewing windows 23, whereas in the open position of the rotary lock, when the actuating shaft 17 is appropriately rotated, the green regions of the flange 26 are visible in the viewing windows 23.

The features of the subject matter of these documents disclosed in the preceding description, the patent claims, the abstract and the drawing can be important individually as well as in any desired combination with one another for realizing the various embodiments of the invention.

1-14. (canceled)

15. A rotary lock for a door or flap, comprising:
a housing that is adapted to be mounted on a panel of the door or flap;
an actuating shaft rotatably disposed in said housing, wherein on a first side of the panel said actuating shaft is connected to a rotary tongue that is fixed against rotation relative to said actuating shaft, and wherein on a second side of the panel said actuating shaft is adapted to be coupled to a lock actuator;
a separate collar adapted to be disposed on the second side of the panel and to cooperate with said housing for securement thereof to the panel;
a fastening nut that is adapted to be threaded on an external thread, disposed on said housing on the second side of the panel, until said fastening nut comes to rest against the panel; and
means for effecting interlocking between said housing and said collar.

16. A rotary lock according to claim 15, wherein said housing is provided with an extension that projects outwardly beyond the panel of the door or flap in a direction toward said collar, and wherein an outer periphery of said extension is adapted to be surrounded by said collar.

17. A rotary lock according to claim 16, wherein said means for effecting interlocking between said housing and said collar is embodied as a bayonet closure.

18. A rotary lock according to claim 17, wherein said interlocking means comprises radially extending projections formed on said extension of said housing as well as recesses formed on said collar, wherein during mounting of said collar and said housing against one another said projections are adapted to be introduced into said recesses, and wherein said projections are adapted to interlock with said collar during relative movement of said collar and said housing relative to one another.

19. A rotary lock according to claim 18, wherein a mounting opening is provided in the panel of the door or flap for accommodating said housing, and wherein at least one support surface, for forming a protection against twisting of said housing in said mounting opening, and that corresponds to one of said projections, is formed on an edge of said mounting opening.

20. A rotary lock according to claim 19, wherein a respective support surface is associated with each of said projections formed on said extension of said housing.

21. A rotary lock according to claim 16, wherein said collar is provided with a first seal disposed on an abutment surface of said collar against the panel of the door or flap, and/or wherein a second seal is disposed between an inner surface of said collar that surrounds said housing, and an outer periphery of said extension of said housing.

22. A rotary lock according to claim 21, wherein at least one of said seals is fixedly connected with said collar.

23. A rotary lock according to claim 22, wherein said seal is foamed.

24. A rotary lock according to claim 22, wherein said seal is integrated into a body of said collar during the manufacture of said collar.

25. A rotary lock according to claim 16, wherein at least one viewing window is formed in said collar, wherein said actuating shaft projects outwardly beyond said extension of said housing that guides said actuating shaft into the region of said at least one viewing window, and wherein said actuating shaft, at its projecting region, is provided with a recognition indication such that a rotational position of said actuating shaft can be determined by said recognition indication, which is visible in said viewing window.

26. A rotary lock according to claim 25, wherein said recognition indication is comprised of different colors.

27. A rotary lock according to claim 25, wherein said recognition indication is comprised of a position indicator that is composed of lettering.
